(19) United States
(12) Patent Application Publication
(10) Pub. No.: US 2006/0182417 A1
(43) Pub. Date: Aug. 17, 2006

(54) Image processor and file data management therein

(76) Inventor: Satoru Sugishita, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/206,913

(22) Filed: Aug. 19, 2005

(30) Foreign Application Priority Data
Feb. 16, 2005 (JP) 2005-039166

(51) Int. Cl. H04N 5/91

(52) U.S. Cl. 386/95

(57) ABSTRACT

An image processor, whose processing function is extended by executing a program of a file stored in externally attachable nonvolatile storage media to and from which data are writable and erasable, is disclosed. The image processor includes multiple attachment parts to which the storage media are attached, a duplication part configured to duplicate the file of a first one of the storage media attached to the attachment parts in a second one thereof, a management part configured to manage the process of the duplication, and an erasure part configured to erase the file being duplicated from the second one of the storage media when the management part detects occurrence of interruption of the duplication.

### BACKGROUND OF THE INVENTION

1. Field of the Invention

The present invention relates generally to image processors processing image data with multiple application programs, such as digital copiers and printers, and more particularly to file data management in an image processor whose function is extensible through a program file stored in an externally attachable nonvolatile storage medium to and from which data are writable and erasable, such as an SD (Secure Digital) card.

2. Description of the Related Art

In conventional digital copiers, a system controller controls necessary operations for processing in accordance with an application program, thereby realizing a copy function. In general, this application program has its data stored in a flash ROM or DIMM (Dual Inline Memory Module) provided on a controller board.

Accordingly, modification or addition of a function is realized by upgrading the version of the application program. For example, Japanese Laid-Open Patent Application No. 2002-14833 (hereinafter, JP2002-14833) discloses a conventional technique of updating the program of an image-forming apparatus by rewriting its built-in flash memory. According to JP2002-14833, it is possible to promote efficiency of rewriting by downloading only the difference between versions from a server PC instead of updating the whole program.

In digital copiers such as MFP (Multi Function Peripheral) machines, expansion of a copy function and addition of printer and facsimile functions to be combined with the copy function are realized by adding corresponding application programs, thereby making it possible to realize extension of functions.

In doing so, recently, with popularity of detachable and reattachable large-capacity portable media, such as SD cards, application programs have been provided using SD card media instead of using a method that updates a program stored in a built-in flash ROM or adds a program (JP2002-14833).

In this case, a user inserts a purchased SD card medium storing an application program into an SD card attachment slot of a main body, thereby making it possible to cause an operation to be performed in accordance with the necessary application program. If an additional function is optional, extending a function with an SD card medium has the merit of easy handling without worrying about insufficiency of the capacity of a built-in flash ROM.

However, the number of slots provided for SD card attachment is limited. Accordingly, it is impossible to attach more SD cards than the number of slots simultaneously. This may cause a situation where a user cannot use all necessary application programs. This is, for example, a situation where some applications become inoperable because of an insufficient number of slots.

The easiest way to counter this is to prepare as many SD card slots as the number of applications. However, in this way, an increase in the number of slots causes an increase in cost, and the physical size of the main body of the image-forming apparatus also becomes a problem. Accordingly, this is not considered a full solution.

Another measure may be to prestore multiple types of applications in an SD card, thereby limiting types of SD cards to be provided to an apparatus user to the number of slots or less. According to this method, however, unnecessary applications may also be provided to the apparatus user.

Accordingly, in order to enable as many necessary applications as possible to be used within the number of SD card slots provided in the main body, a proposal has been made to eliminate the above-described disadvantages by storing necessary data by integrating files stored in multiple SD cards and thereby making the most of card capacity.

However, this conventional technique does not assume interruption of processing after the start of file duplication that is performed during integration of files. Accordingly, if the duplication processing is suspended because of an unexpected accident such as power failure, unnecessary files resulting from the duplication remain in a storage medium. This works against the original purpose of using as many applications as possible, thus causing a problem. This problem still remains unsolved.

Thus, the conventional technique of making a data writable/erasable nonvolatile storage medium such as an SD card externally attachable and detachable, and realizing function extension by adding a program file using such a storage medium has problems including those described above.

### SUMMARY OF THE INVENTION

Accordingly, it is a general object of the present invention to provide an image processor in which the above-described disadvantages are eliminated.

A more specific object of the present invention is to provide an image processor that can restore a storage medium to a condition where effective use of the storage area of the storage medium is not prevented even if duplication processing performed between the storage medium and another storage medium is suspended because of an accident.

Another more specific object of the present invention is to provide a computer-readable program product storing a program for causing a computer controlling the operation of the image processor to execute management capable of handling a case where interruption of duplication processing is caused by power failure or the like and intended restoration cannot be achieved immediately.

One or more of the above objects of the present invention are achieved by an image processor of which a processing function is extended by executing a program of a file stored in externally attachable nonvolatile storage media to and from which data are writable and erasable, the image processor including: a plurality of attachment parts to which the storage media are attached; a duplication part configured to duplicate a file of a first one of the storage media attached to the attachment parts in a second one thereof; a management part configured to manage a process of the duplication; and an erasure part configured to erase the file being duplicated from the second one of the storage media when the management part detects occurrence of interruption of the duplication.

One or more of the above objects of the present invention are also achieved by a computer-readable program product storing a program for causing a computer to execute a method, the computer controlling an operation of an image processor of which a processing function is extended by executing a program of a file stored in externally attachable nonvolatile storage media to and from which data are writable and erasable, the method including the steps of: (a) duplicating a file of a first one of the storage media in a second one thereof; (b) creating, in the second one of the storage media, a log file to record information on the file to be duplicated; (c) detecting occurrence of interruption of the duplication while the duplication is in process; (d) identifying the file being duplicated based on the information on the file recorded in the log file when the occurrence of the interruption of the duplication is detected; and (e) erasing the identified file from the second one of the storage media.

According to the above-described inventions, when occurrence of interruption of a duplication operation is detected during its process, it is possible to identify a file that is being duplicated and erase the identified file from a destination storage medium in which the file is to be duplicated. Accordingly, it is possible to prevent an unnecessary file from remaining in the destination storage medium, thus making it possible to use its storage area effectively. As a result, it is possible to improve ease of apparatus use by using a filing function that stores file data with the best use of the capacity of a storage medium.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram showing a program configuration of a digital copier according to an embodiment of the present invention;

FIG. 2 is a block diagram for illustrating the operation of integrating files stored in multiple SD cards according to the embodiment of the present invention;

FIG. 3 is a flowchart of the integration operation enabling recovery from interruption of a duplication operation according to the embodiment of the present invention;

FIG. 4 shows a log file created in a destination SD card in the duplication operation according to the embodiment of the present invention;

FIG. 5 is a flowchart showing an operational flow in the case of restoring an SD card in which unnecessary data remain because of interruption of the duplication operation according to the embodiment of the present invention; and

FIG. 6 is a flowchart of the operation of duplicating address book data according to the embodiment of the present invention.

### DETAILED DESCRIPTION OF THE PREFERRED EMBODIMENTS

A description is given, with reference to the accompanying drawings, of an embodiment of the present invention. The embodiment described below is a case where the image processor of the present invention is applied to a digital copier.

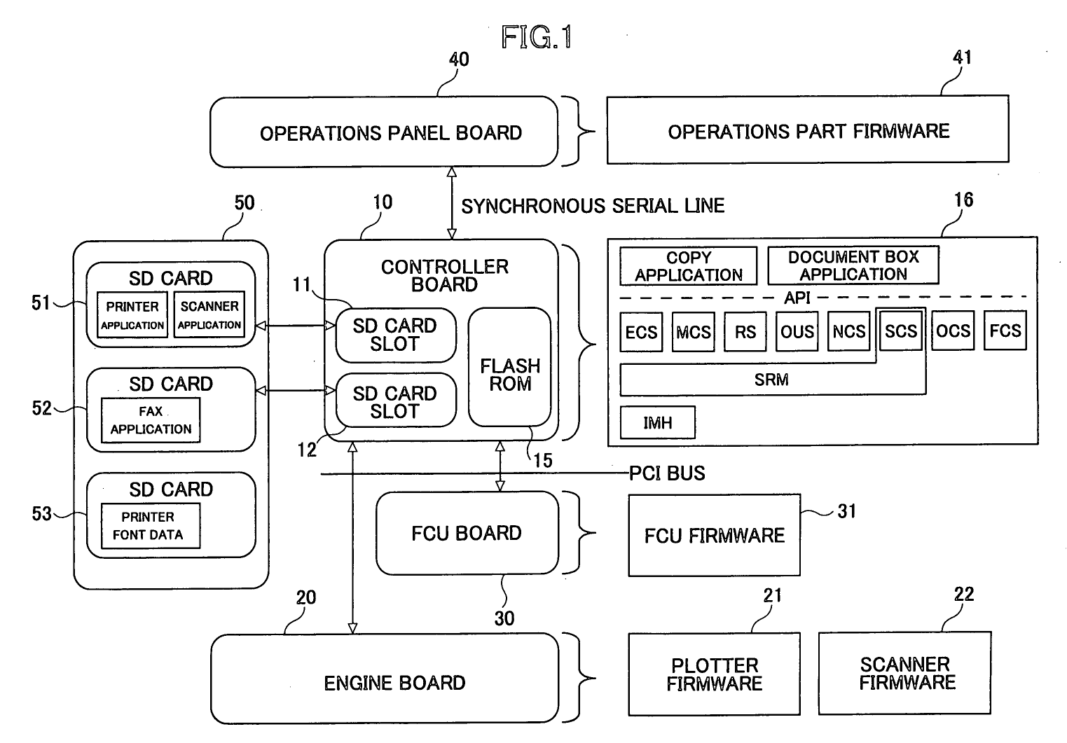

FIG. 1 is a block diagram showing a program configuration of a digital copier according to the embodiment of the present invention.

The digital copier (apparatus) of the present invention is a so-called MFP (Multi Function Peripheral) machine, in which multiple functions such as a copy function, a printer function, a facsimile (FAX) function, and a scanner function are provided in a single unit.

A control unit of the digital copier includes an engine board 20, an FCU (facsimile control unit) board 30, an operations panel board 40, and a controller board 10. The controller board 10, which is connected to each of the control boards 20, 30, and 40, controls the operations of the entire apparatus as a main control unit.

The engine board 20 is a control board controlling an engine part provided in the apparatus. The FCU board 30 is a control board controlling a facsimile transmission and reception part provided in the apparatus. The operations panel board 40 is a control board controlling the operations of an operations part provided in the apparatus.

Of the above-described control boards 10, 20, 30, and 40, the controller board 10 performing main control has various controller control programs (ECS, IMH, SCS, SRM, etc.) and application programs such as a copy application and a document box application installed therein. The control programs and the application programs, which are collectively referred to by reference numeral 16, are stored in a flash ROM 15 mounted on the controller board 10.

Firmware for operations part control (operations part firmware) 41 is mounted on the operations panel board 40, which is connected to the controller board 10 through a synchronous serial line. Further, the FCU board 30, which receives and transmits facsimile documents, and the engine board 20, which performs scanner reading, conveyance of printing paper, and writing of image data, are connected to the controller board 10 through a PCI bus. FCU firmware 31 is mounted on the FCU board 30. Plotter firmware 21 and scanner firmware 22 are mounted on the engine board 20.

The controller board 10 includes SD (Secure Digital) card slots 11 and 12 (attachment parts) for attachment of SD cards. The SD card, which is a large-capacity portable storage medium, is a card-type flash memory. The flash memory is a data writable/erasable nonvolatile storage medium. Here, the SD card is employed in order to provide an application program file therefrom. In this embodiment, SD cards 51, 52, and 53 are employed, for example. The SD cards 51 through 53 may be collectively referred to as an SD card 50. When the SD card 50 is attached to the SD card slot 11 or 12, it is possible to cause the apparatus main body to operate in accordance with an application program stored in the SD card 50.

In this embodiment, the two SD card slots 11 and 12 are provided on the controller board 10 as shown in FIG. 1. Here, the SD card 50 provides a program file necessary for an additional function other than normally installed functions such as a copy function. In this embodiment, the single SD card 51 provides the two program files of a printer application and a scanner application. Further, the SD card 52 provides the program file of a FAX application. Further, in order to extend types of fonts usable in the printer application, the SD card 53 storing font data is prepared separately. In the case of using a program provided by the SD card 50, a user selects one or more of the SD cards 51 through 53 which the user wishes to use, and attaches the selected one or more of the SD cards 51 through 53 to the SD card slot 11 and/or the SD card slot 12. Thereby, it is possible to extend or expand the functions of the copier.

The apparatus configuration of the digital copier other than the program configuration described above with reference to FIG. 1 may be implemented with a normal configuration of a digital copier having well-known multiple functions, and accordingly, a description thereof is omitted.

Next, a description is given of management of a program file provided by the SD card 50 employed in the above-described copier.

In the case of providing a program file from the SD card 50, as shown in the above-described embodiment (FIG. 1), the number of SD card slots provided in the main body is limited (two in the illustrated case). Accordingly, in order to make it possible to use as many necessary applications as possible under that limiting condition, it is necessary to store file data with the best use of the capacity of the SD card 50. Accordingly, in this embodiment, an integration function that puts together files stored in multiple SD cards is employed.

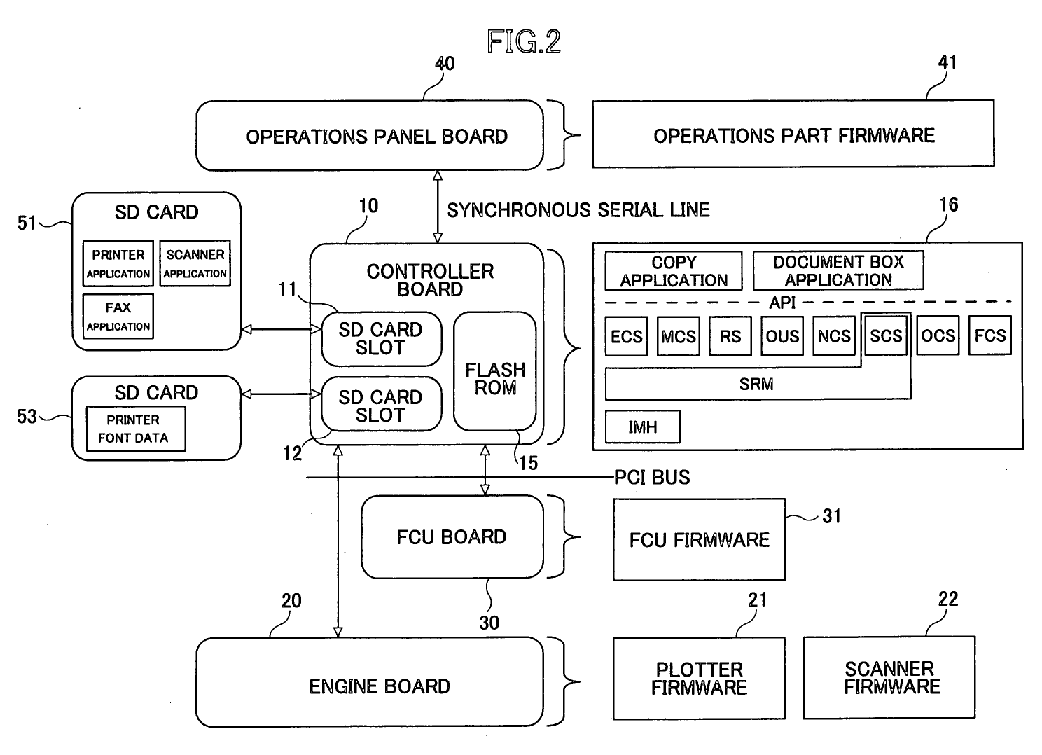

FIG. 2 is a block diagram for illustrating the operation of integrating files stored in multiple SD cards. The SD cards 51 and 53 shown in FIG. 2 show the results of the integration operation. Specifically, the SD card 51 storing the printer application and the scanner application and the SD card 52 storing the FAX application shown in FIG. 1 are integrated, so that the three applications are put together in the single SD card 51 as shown in FIG. 2. Thus, the files are integrated using the function of putting files together in a single SD card. Conventionally it is impossible to perform all the corresponding operations simultaneously unless three or more types of SD cards are attached in the configuration of FIG. 1. However, by putting application programs and data together as shown in FIG. 2, it is possible to perform all the corresponding operations. Further, if storage capacity permits, it is possible to perform all the corresponding operations with a single SD card by repeating the integration operation.

The integration operation, which puts files stored in multiple SD cards together, requires duplication of program file data between SD cards and file management accompanying the duplication (described in detail below). A function for performing these operations is prepared in the controller board 10 (for example, in a computer-readable program product such as the flash ROM 15). This function is installed as one of operation programs driven by the CPU of the controller board 10.

The function of duplicating data between SD cards can be implemented by applying a function commonly used in duplicating data between memories. In the case of actually executing the integration operation, an input operation for using this function is performed on the display screen of an operations panel under the control of the controller board 10. Thereby, an operations program is started. On the operations screen, a user selects a program file to be duplicated from the program files stored in a first SD card and specifies a second SD card in which the selected program file is to be duplicated, and gives an instruction for the execution. As a result, the duplication operation is performed in accordance with a program as part of the integration operation.

The above-described program file integration operation makes it possible to store file data with the best use of card capacity. However, if the integration operation is interrupted, the storage area may be occupied by unnecessary data. This situation may result in the problem of preventing the original purpose of making the best use of card capacity from being achieved.

In this embodiment, measures are taken to enable a storage medium to be restored to a condition where effective use of its storage area is not prevented even in the case of interruption of the duplication operation performed as part of the integration operation, in particular, interruption of the duplication operation performed between SD cards due to an unexpected accident such as a power shutdown.

According to this embodiment, a program file that is being duplicated at the time of occurrence of interruption of its duplication is managed, thereby making it possible to erase data remaining as unnecessary data in an SD card to which the program file is to be duplicated, thus restoring the storage area of the SD card.

A method for managing a file in the process of duplication and thereby making it possible to recover from interruption of the duplication is based on the following method. That is, according to this method, a log file recording information on a file to be duplicated is created, and when the duplication of the file is interrupted during its process, the file that is being duplicated is identified based on the file information recorded in the log file, and unnecessary data are erased from a storage medium in which the file is to be duplicated based on the identified file information.

A description is given of a configuration of the file integration operation including a procedure that enables recovery from interruption of the duplication operation.

Normally, copiers are equipped with the function of checking stored program files. Accordingly, a function for executing the file integration operation is added as part of the checking function. It is possible to perform a restoration operation by a method capable of using the function. For example, it is possible to employ the following method. That is, at the time of file checking, a function key for the file integration operation is provided on an operations part that displays a list of program files stored in an SD card, and this operation is started by a press of the key by a user.

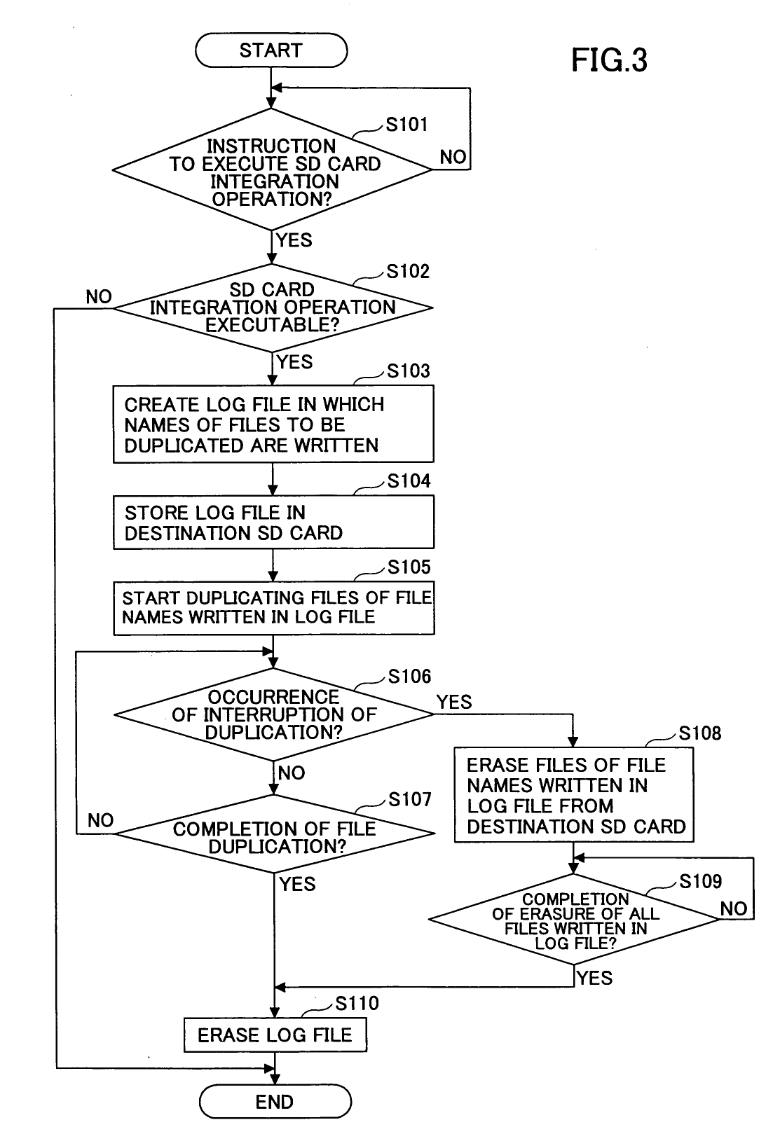

FIG. 3 is a flowchart of the integration operation enabling recovery from interruption of the duplication operation according to this embodiment.

Referring to the operational flow of FIG. 3, first, in step S101, a CPU determines whether to execute the SD card (file) integration operation. That is, according to the above-described example, the CPU confirms an instruction to execute the file integration operation (an execution instruction) with the input of an operation on the function key of the file integration operation provided on the screen of the operations part. At this point, multiple SD cards are attached. Accordingly, a user is required to specify SD cards to be subjected to duplication (integration), that is, an SD card of which a file is to be duplicated (a source SD card) and an SD card in which the file is to be duplicated (a destination SD card).

If the user gives an instruction to execute the SD card integration operation (YES in step S101), next, in step S102, the CPU determines whether it is possible to execute the SD card integration (duplication) operation.

According to this embodiment, this determination is made in accordance with the following conditions (a) through (e).

(a) Whether the SD cards are attached to corresponding slots correctly.

(b) Whether sufficient storage capacity remains in the destination SD card.

(c) Whether the destination SD card is write-protected.

(d) Whether the source SD card allows duplication.

(e) Whether the SD cards to be subjected to duplication have a file name in common.

The CPU determines whether the SD card duplication operation is executable based on these conditions. If all the conditions (a) through (e) are not satisfied, the CPU determines that it is impossible to execute the integration operation (NO in step S102), and leaves this operational flow without executing the SD card integration operation.

If all the conditions (a) through (e) are satisfied, the CPU determines that it is possible to execute the integration operation (YES in step S102), and in step S103, the CPU creates a log file for the integration operation (file name: gw_logfile.log) in which the list names of all files in the source SD card are recorded as duplication target files. In this embodiment, a case of the integration operation where all program files in an SD card are integrated together with another SD card is shown. Alternatively, it is also possible to subject part of the program files to the integration operation. In this case, a user is required to specify target files by selecting them.

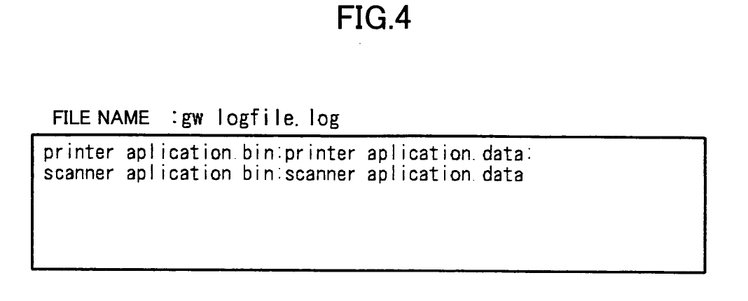

FIG. 4 shows an example of the log file created at this point. The log file of FIG. 4 shows a case where four files printer_application.bin, printer_application.data, scanner_application.bin, and scanner_application.data, for example, are stored in the source SD card. As shown in FIG. 4, the four files are enumerated, being set off by colons (:), thereby making it possible to mark off the boundary between file names.

Next, in step S104, the CPU stores the created log file in the destination SD card, enabling the log file to be used as management information. The CPU stores the log file in the destination SD card in order to make subsequent restoration possible even in the case of interruption of the duplication operation, in particular, interruption of the duplication operation performed between SD cards due to an unexpected accident such as a power shutdown. This is because it is considered reasonable to provide an SD card requiring restoration with the data of the log file, since the SD card is a nonvolatile medium from which data are not erased and there is the effect of the interruption that unnecessary data remain in the destination SD card.

Next, in step S105, the CPU starts duplicating a file corresponding to a file name written in the log file.

After the start of the duplication, the CPU checks occurrence of interruption of the duplication, and performs a necessary operation at the time of occurrence of the interruption. In the operational flow of FIG. 3, in step S106, the CPU repeatedly checks occurrence of interruption of the duplication with predetermined timing, for instance, at predetermined intervals. If it is required to interrupt the duplication by a user's instruction, etc., while duplicating a file (YES in step S106), in step S108, the CPU erases files corresponding to the file names written in the log file (a file whose name is gw_logfile.log shown in FIG. 4) from the destination SD card. In the case of interrupting the duplication operation by a user's instruction, etc., data that have been duplicated so far become useless and occupy a storage area in vain. Accordingly, the CPU erases the data so as to place the destination SD card in a usable condition.

As described above, the end of each file to be erased can be identified in the log file, using a colon (:) as an identifier. Accordingly, the CPU erases files whose duplication is interrupted one after another referring to the description of the log file, thereby erasing all files written in the log file from the destination SD card.

If the CPU completes restoration, erasing all the files in the log file (YES in step S109), in step S110, the CPU also erases the log file stored in the destination SD card. A condition where the log file is not erased means incompletion of restoration. Accordingly, the CPU erases the log file when completing restoration.

On the other hand, if the file duplication ends normally without any interruption to the end (YES in step S107), the CPU also erases the log file stored in the destination SD card.

As described above, by executing the file integration operation enabling recovery from interruption of the duplication operation, it is possible to have the storage condition of the destination SD card remain the same before and after the interruption, thus making it possible to prevent waste of resources due to creation of unnecessary files in the destination SD card, even when the duplication operation is interrupted.

In the above-described file integration operation (FIG. 3), occurrence of interruption of the duplication operation is checked for. However, an interruption due to a cause that escapes this check, for instance, an accidental power shutdown, may occur. In this case, the operation shown in FIG. 3 is not performable. Accordingly, immediate restoration of the SD card is impossible.

According to the following method, even in this case, it is possible to restore an SD card as in the above-described operational flow at the time of subsequent use of the SD card.

The SD card is restorable on condition that the log file is created (step S103) in the above-described file integration operation (FIG. 3). The log file is written to an SD card, which is a nonvolatile memory. Accordingly, the data are prevented from being erased even in the case of, for instance, a power shutdown. Further, the SD card in which the log file is written is the destination SD card requiring restoration. Accordingly, it is possible to perform restoration when the SD card is used next time.

The following is a case where the operation of restoring an SD card (restoration operation) is performed as part of initialization of the apparatus at the time of turning on power.

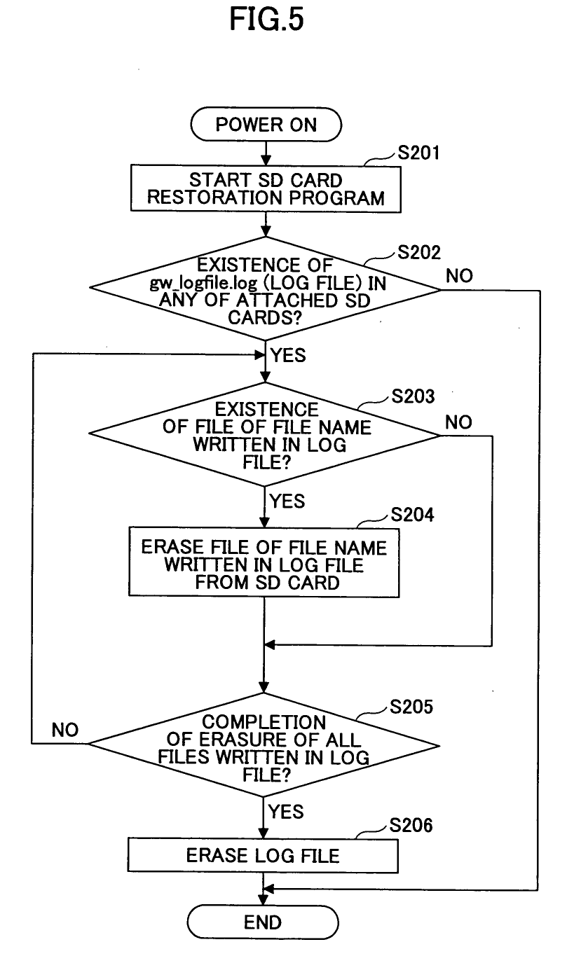

FIG. 5 is a flowchart showing an operational flow in the case of restoring an SD card in which unnecessary data remain because of interruption of the duplication operation. Referring to the operational flow shown in FIG. 5, first, in step S201, when the apparatus is turned on, the CPU starts an SD card restoration program in an operation performed as part of initialization of the apparatus without a user's instruction.

In step S202, in the beginning of the restoration operation, the CPU determines with respect to each of SD cards attached to the SD card slots of the apparatus whether the SD card stores a log file. The CPU determines whether a file existing in the SD card is a log file, or identifies a log file, by retrieving a file of a particular name “gw_logfile.log” that is used only for a log file.

If no log file is found in any of the SD cards (NO in step S202), no SD card requires restoration. Accordingly, the CPU ends this operational flow without performing any further operation.

On the other hand, if a log file is found in any of the SD cards (YES in step S202), in step S203, the CPU conducts a search to determine whether a file of a name written in the log file (FIG. 4) is stored in the corresponding SD card. If such a file name is found (YES in step S203), in step S204, the CPU erases a file corresponding to the file name from the SD card. A file written in the found log file is a file of which duplication has been interrupted, so that meaningless data duplicated before the interruption occupy a storage area uselessly. Accordingly, in step S204, the data are erased from the SD card in order to restore the SD card to a usable condition.

The CPU can identify a file to be erased as an individual file name by using a colon (:) as an identifier as shown in FIG. 4. The CPU erases files of which duplication has been interrupted one after another referring to the description of the log file, and erases all the files written in the log file from the SD card.

If the CPU completes restoration, erasing all the files in the log file (YES in step S205), in step S206, the CPU also erases the log file stored in the corresponding SD card. A condition where the log file is not erased means incompletion of restoration. Accordingly, the CPU is required to erase the log file when completing restoration.

Even if the duplication operation is interrupted, storing a log file in the destination SD card as described above makes it possible to erase useless files at the time of next use of the SD card without a user's instruction, thus making it possible to effectively execute the integration operation of file data recorded in SD cards, which are detachable and reattachable storage media.

The operation described with reference to FIG. 5 is based on the premise of creation of a log file. Accordingly, next, a description is given of the case where an accidental power shutdown occurs during creation of a log file. In this condition, either no log file is created or a log file to which duplication file information is halfway written is created.

If no log file is created, no file is duplicated. Accordingly, the apparatus operates normally. If a log file in which duplication file information is halfway written is created, the file information written in the log file is erased, but it is only that a file that does not exist is not erased. Accordingly, the apparatus operates normally.

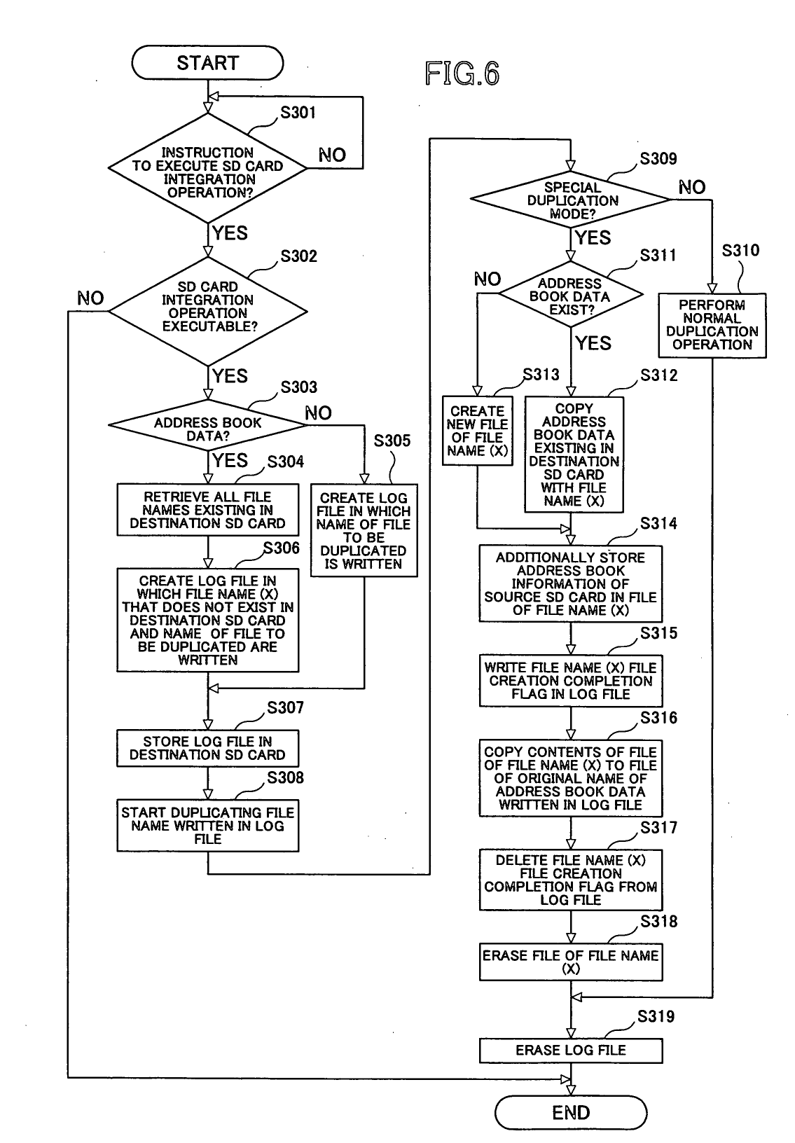

Next, a description is given, with reference to FIG. 6, of duplication of address book data. Simply copying address book data from a source SD card to a destination SD card leads to erasure of information recorded only in the destination SD card. Accordingly, it is not allowed to simply copy address book data.

First, in step S301, the CPU confirms execution of the SD card integration operation. That is, according to the above-described case, the CPU confirms an execution instruction with the input of an operation on the function key of the file integration operation provided on the screen of the operations part. At this point, multiple SD cards are attached. Accordingly, a user is required to specify SD cards to be subjected to duplication (integration), that is, a source SD card and a destination SD card.

If the user gives an instruction to execute the SD card integration operation (YES in step S301), next, in step S302, the CPU determines whether it is possible to execute the SD card integration (duplication) operation.

If the CPU determines that it is possible to execute the integration operation (YES in step S302), in step S303, the CPU determines whether a file to be duplicated is address book data. If the file to be duplicated is not address book data (NO in step S303), in step S305, the CPU creates a log file in which the name of the file to be duplicated is written, and proceeds to step S307.

If the file to be duplicated is address book data (YES in step S303), in step S304, the CPU retrieves all file names existing in the destination SD card. Next, in step S306, the CPU creates a log file in which a file name (X) that does not exist in the destination SD card and the name of the file to be duplicated are written. In this step S306, using a flag or the like, the CPU stores the information that the operation mode is a special duplication mode indicating duplication of address book data. The file name (X) is written in order to prevent the destination SD card from being overwritten.

In step S307, the CPU stores the log file in the destination SD card. Next, in step S308, the CPU starts duplicating the file name written in the log file. In step S309, the CPU determines whether the special duplication mode is entered. If the special duplication mode is not entered (NO in step S309), in step S310, the CPU performs a normal duplication operation, and proceeds to step S319.

In the case of the special duplication mode (YES in step S309), in step S311, the CPU determines whether address book data exist in the destination SD card. If no address book data exist (NO in step S311), in step S313, the CPU creates a new file of the file name (X), and proceeds to step S314.

If address book data exist (YES in step S311), in step S312, the CPU copies the address book information of the destination SD card with the file name (X). That is, the CPU creates a duplicate of the address book information of the destination SD card, and assigns the file name (X) to the duplicate.

In step S314, the CPU additionally stores the address book information of the source SD card in the file of the file name (X). When the storage is completed, in step S315, the CPU writes a flag indicating completion of creation of the file of the file name (X) (file name (X) file creation completion flag) in the log file. In step S316, the CPU copies the contents of the file of the file name (X) to a file of the original name of the address book information written in the log file.

In step S317, the CPU deletes the file name (X) file creation completion flag from the log file. Next, in step S318, the CPU erases the file of the file name (X). Then, in step S319, the CPU erases the log file, and ends the operation.

For example, the log file of step S306 is described as follows:

SLOT 1: tmpFileX: AddressDataA,

where “tmpFileX” is a file name that is not used in the destination SD card (attached to SLOT 1, for instance, the SD card slot 11, in this case), and “AddressDataA” is the original file name.

For example, the log file of step S315 is described as follows:

SLOT 1: tmpFileX: AddressDataA: Complete.

This indicates completion of creation of a file.

Further, when an interruption occurs, only the file of the file name (X) is erased in the special duplication mode. However, with respect to a file for which “Complete” as described above is written in the log file, replacement of file information, which is the operation of steps S316 through S318, is performed instead of erasure.

The method of identifying a log file by the name of the log file in the above-described embodiment is a mere example. Instead of using the name of a log file, the log file may be created under a special directory or information for identifying the log file may be embedded in the contents of the log file as long as the name of the log file can be identified.

Further, in the above-described embodiment, the format of a log file employs a colon (:) as an identifier. Alternatively, other symbols and a linefeed character are also employable as identifiers as long as file names written in the log file can be identified.

An image processor according to the present invention, of which a processing function is extended by executing a program of a file stored in externally attachable nonvolatile storage media to and from which data are writable and erasable, includes: multiple attachment parts to which the storage media are attached; a duplication part configured to duplicate the file of a first one of the storage media attached to the attachment parts in a second one thereof; a management part configured to manage a process of the duplication; and an erasure part configured to erase the file being duplicated from the second one of the storage media when the management part detects occurrence of interruption of the duplication.

A computer-readable program product according to the present invention stores a program for causing a computer to execute a method, the computer controlling an operation of an image processor of which a processing function is extended by executing a program of a file stored in externally attachable nonvolatile storage media to and from which data are writable and erasable, the method including the steps of: (a) duplicating the file of a first one of the storage media in a second one thereof; (b) creating, in the second one of the storage media, a log file to record information on the file to be duplicated; (c) detecting occurrence of interruption of the duplication in the process of the duplication; (d) identifying the file being duplicated based on the information on the file recorded in the log file when the occurrence of the interruption of the duplication is detected; and (e) erasing the identified file from the second one of the storage media.

Thus, according to the present invention, when occurrence of interruption of a duplication operation is detected during its process, it is possible to identify a file that is being duplicated and erase the identified file from a destination storage medium in which the file is to be duplicated. Accordingly, it is possible to prevent an unnecessary file from remaining in the destination storage medium, thus making it possible to use its storage area effectively. As a result, it is possible to improve ease of apparatus use by using a filing function that stores file data with the best use of the capacity of a storage medium.

In addition, in the image processor of the present invention, the management part may create, in the second one of the storage media, a log file to record information on the file to be duplicated, and employs the log file to identify the file when the duplication of the file is interrupted.

In addition, the image processor of the present invention may include a log file erasure part configured to erase the log file created by the management part when the erasure of the data of the file being duplicated is completed in the second one of the storage media.

In addition, the image processor of the present invention may include a determination part configured to determine existence of the log file among the storage media with any timing; and a file erasure part configured to erase the file recorded in the log file if the log file exists.

According to the above-described features of the present invention, a log file to record information on a file to be duplicated is created in a destination storage medium in which the file is to be duplicated. Accordingly, even if duplication of the file is interrupted in any form (for instance, even in the case where the interruption is caused by, for instance, power failure, so that it is impossible to perform intended restoration immediately), it is possible to support a restoration operation. Further, existence of the log file is checked for (presence or absence of the log file is determined) with respect to each storage medium, and an unnecessary file is automatically erased. This eliminates the need for a user to give an instruction to erase an unnecessary file and perform a corresponding operation. Accordingly, it is possible to improve ease of apparatus use.

The present invention is not limited to the specifically disclosed embodiment, and variations and modifications may be made without departing from the scope of the present invention.

The present application is based on Japanese Patent Application No. 2004-044882, filed on Feb. 20, 2004, and Japanese Priority Patent Application No. 2005-039166, filed on Feb. 16, 2005, the entire contents of which are hereby incorporated by reference.

What is claimed is:

1. An image processor of which a processing function is extended by executing a program of a file stored in externally attachable nonvolatile storage media to and from which data are writable and erasable, the image processor comprising:
a plurality of attachment parts to which the storage media are attached;
a duplication part configured to duplicate a file of a first one of the storage media attached to the attachment parts in a second one thereof;
a management part configured to manage a process of the duplication; and
an erasure part configured to erase the file being duplicated from the second one of the storage media when the management part detects occurrence of interruption of the duplication.

2. The image processor as claimed in claim 1, wherein the management part creates, in the second one of the storage media, a log file to record information on the file to be duplicated, and employs the log file to identify the file when the duplication of the file is interrupted.

3. The image processor as claimed in claim 2, further comprising:
a log file erasure part configured to erase the log file created by the management part when the erasure of data of the file being duplicated is completed in the second one of the storage media.

4. The image processor as claimed in claim 2, further comprising:
a determination part configured to determine existence of the log file among the storage media with any timing; and
a file erasure part configured to erase the file recorded in the log file if the log file exists.

5. A computer-readable program product storing a program for causing a computer to execute a method, the computer controlling an operation of an image processor of which a processing function is extended by executing a program of a file stored in externally attachable nonvolatile storage media to and from which data are writable and erasable, the method comprising the steps of:
(a) duplicating a file of a first one of the storage media in a second one thereof;
(b) creating, in the second one of the storage media, a log file to record information on the file to be duplicated;
(c) detecting occurrence of interruption of the duplication while the duplication is in process;
(d) identifying the file being duplicated based on the information on the file recorded in the log file when the occurrence of the interruption of the duplication is detected; and
(e) erasing the identified file from the second one of the storage media.
